(19) United States
(12) Patent Application Publication
(10) Pub. No.: US 2012/0181415 A1
(43) Pub. Date: Jul. 19, 2012

(54) PROJECTOR MOUNT

(75) Inventors: David Woodcock, Blackburn (GB); Howard Gallimore, Blackburn (GB)

(73) Assignee: PROMETHEAN HOUSE, Blackburn Lancashire (GB)

(21) Appl. No.: 13/375,472

(22) PCT Filed: May 25, 2010
(86) PCT No.: PCT/EP2010/057174

§ 371 Date: Mar. 15, 2012

(30) Foreign Application Priority Data
Jun. 1, 2009 (GB) 0909415.2

(51) Int. Cl. F16M 13/02

(52) U.S. Cl. 248/674

(57) ABSTRACT

The invention relates to an apparatus (30) for mounting a projector (2) to an overhead projector support, comprising: a. a first mount portion (6) including a first pivot means (20) and a first fixing means (24); b. a second mount portion (8) including a second pivot means (18) for cooperating with the first pivot means and a second fixing means (26) for cooperating with the first fixing means.

### BACKGROUND TO THE INVENTION

1. Field of the Invention

The present invention relates generally to mounts for projectors, preferably but not exclusively a mount for an integrated projector system such as an interactive whiteboard.

2. Description of the Related Art

Interactive whiteboard systems are well-known in the art, and are particularly well-known for use in educational applications in colleges and schools. An interactive whiteboard system typically includes an interactive surface forming a whiteboard, and a projector for displaying images onto the interactive surface. The interactive surface and projector are operated under the control of a computer system. One skilled in the art will be familiar with the implementation and operation of such interactive whiteboard systems.

An integrated interactive whiteboard system is understood to be one in which the projector and whiteboard are integrated. A typical integrated system comprises an arrangement in which an arm or boom is attached to the whiteboard, or a frame supporting the whiteboard, and extends perpendicular from the whiteboard surface. A projector is then fixed to the end of the arm or boom remote from the whiteboard. Such integrated interactive whiteboard systems have advantages over traditional whiteboard systems, which require the projector to be separately mounted to the ceiling within a classroom. The integration of such systems makes the installation of the systems in a classroom environment easier, and also allows for the provision of portable interactive whiteboard systems which may be moved around between different classrooms.

In an integrated interactive whiteboard system, it is necessary to provide a means for securely attaching the projector to the arm or boom in such a way that it is safely and securely attached in use. Examples of apparatus for attaching a projector to a projector support can be found, for example, in European Patent Application Publication No. 1852646, International Patent Application Publication No. WO 2005/069992, US Patent Application Publication No. 2005/035253, and US Patent Application Publication No. US 2008/0179475.

In an integrated interactive whiteboard arrangement it may also be necessary to remove the projector from the boom or arm from time-to-time. This may be, for example, to facilitate maintenance of the projector, to remove the projector for transport or secure storage, or for other purposes. Thus whilst the means for attaching the projector to the arm or boom must be secure and robust, it must also facilitate the safe and straightforward removal of the projector.

It is an object of the present invention to provide an improved projector mount which allows for a projector to be securely fitted for use, and also safely removable when necessary.

### SUMMARY OF THE INVENTION

The invention provides an apparatus for mounting a projector to an overhead projector support, comprising: a. a first mount portion including a first pivot means and a first fixing means; b. a second mount portion including a second pivot means for cooperating with the first pivot means and a second fixing means for cooperating with the first fixing means.

The first mount portion may comprise a first elongated portion, wherein the first pivot means is positioned at a first end of the first elongated portion and the first fixing means is positioned at a position of the first elongated portion distant from the first pivot means, and the second mount portion may comprise a second elongated portion, wherein the second pivot means is positioned at a first end of the second elongated portion and the second fixing means is positioned at a position of the second elongated portion distant from the second pivot means.

The first fixing means may be positioned at a second end of the first elongated portion and the second fixing means may be positioned at a second end of the second elongated portion.

The first elongated portion may comprise a first longitudinal channel and the second elongated portion comprises a second longitudinal channel, wherein the first and second longitudinal channels are arranged to cooperate with each other to connect the first and second mount portions.

The first longitudinal channel may be formed of a first pair of parallel elongated sidewalls and the second longitudinal channel is formed of a second pair of parallel elongated sidewalls.

The distance between one pair of elongated sidewalls may be greater than the other, such that one pair of elongated sidewalls fits inside the other.

Each elongated sidewall of the first longitudinal channel may be formed with a hook shape at a first end thereof, which form the first pivot means.

The second pivot means may be formed of a bar between the ends of the sidewalls at the second end of the second longitudinal channel.

The first longitudinal channel may comprise a further sidewall forming an end sidewall at the second end thereof between the parallel sidewalls. The first fixing means may comprise a fixing slot positioned in the further sidewall.

The second longitudinal channel may comprise a further sidewall forming an end sidewall at the second end thereof between the parallel sidewalls. The second fixing means may comprise a retained nut in the further sidewall of the second longitudinal channel. There may be provided a third fixing means for securing the first and second means. The third fixing means is a screw which passes through the fixing slot to engage with the retained nut. The slot may be an elongated slot having a retaining wall, wherein when the screw is secured the second fixing means abuts the retaining wall to fix the first and second mount portions.

The first pivot means may include an elongated slot in the first elongated portion, and the second pivot means may include means for engaging said slot, wherein with the first and second fixing means unsecured the second pivot means can slide in and out of said elongated slot, and with the first and second fixing means secured the second pivot means abuts an edge of the elongated slot to prevent movement of the second mount portion relative to the first mount portion.

The elongated slot may extend along the sidewall from the first end thereof for a fixed distance, wherein a first portion of the elongated slot adjacent the first end provides a channel for receiving the second pivot means, and a second portion of the elongated slot distal the first end extends in a direction perpendicular to the elongated channel. The elongated slot may further comprise a third portion extending from the perpendicularly extended part of the second portion in the direction of the elongated slot partially toward the first end, and in the perpendicular direction partially toward the first portion. The wall of the third portion distal the first end may be curved. With the first and second mount portions secured, the second pivot means may abut the curved wall distal the first end.

The wall of the third portion proximate the first end may be curved. With the first and second mount portions unsecured the second pivot means may abut the curved wall proximate the first end.

The first mount portion may be adapted for fixing to a support boom for the projector.

The second mount portion may be adapted for fixing to the projector. The second mount portion may be welded to a faceplate.

### BRIEF DESCRIPTION OF THE FIGURES:

The invention will now be described by way of example with reference to the accompanying figures, in which:

FIG. 1 illustrates a projector with a projector mount in accordance with a preferred embodiment of the invention;

FIG. 2 illustrates a view of a projector mount similar to that of FIG. 1, without the projector;

FIG. 3 illustrates a first part of the projector mount of FIG. 2, for connecting to a projector support;

FIG. 4 illustrates a second part of the projector mount of FIG. 2, for connecting to a projector;

FIG. 5 illustrates a first pivot or fixing and release mechanism of the projector mount of FIGS. 1 to 4 in accordance with a preferred embodiment;

FIG. 6 illustrates a second fixing and release mechanism of the projector mount of FIGS. 1 to 4 in accordance with a preferred embodiment;

FIG. 7 illustrates the release operation of a projector using a projector mount of a preferred embodiment; and

FIG. 8 illustrates the removal of a projector in accordance with a projector mount of a preferred embodiment.

### DESCRIPTION OF THE PREFERRED EMBODIMENTS

The invention will now be described by way of reference to a particular preferred embodiment. One skilled in the art will appreciate that the invention is not limited to the specifics of the embodiment described herein. Various modifications to the embodiments may be made within the scope of the invention.

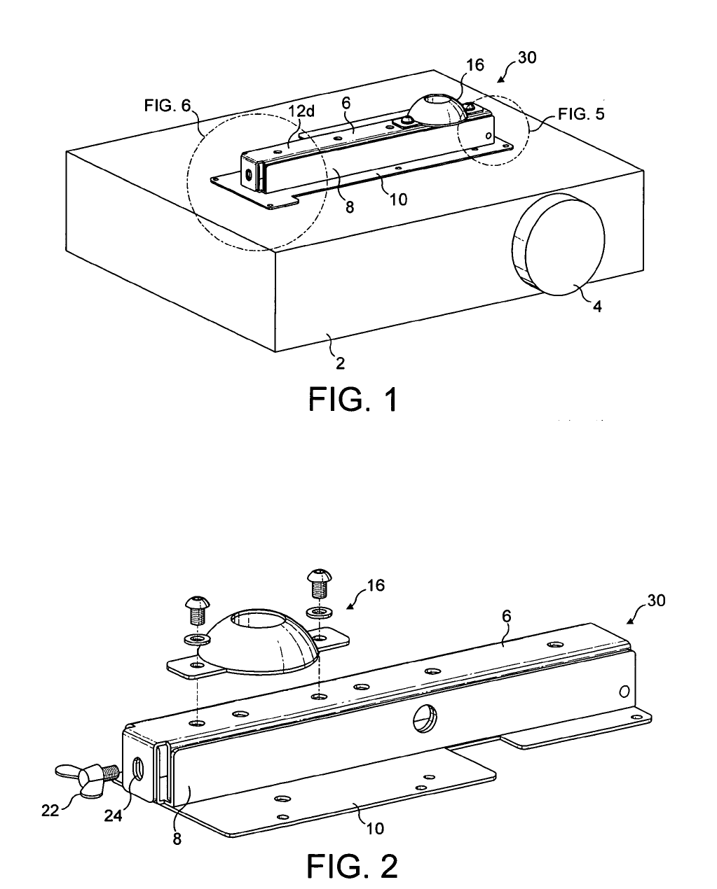

With reference to FIG. 1 there is illustrated a projector 2 including a projector lens 4. The invention is not concerned with the structure or operation of any particular projector, and therefore no specific details of the projector are shown in the figures or described herein.

In the following description like reference numerals in different Figures are used to refer to the same element or feature occurring in different Figures.

Generally identified by reference numeral 30 in FIG. 1 is a projector mount in accordance with a preferred embodiment of the invention, for fixing the projector 2 to a projector support such as an arm or boom of an integrated interactive whiteboard system. The projector mount 30 is also illustrated in FIG. 2, in a somewhat different structure.

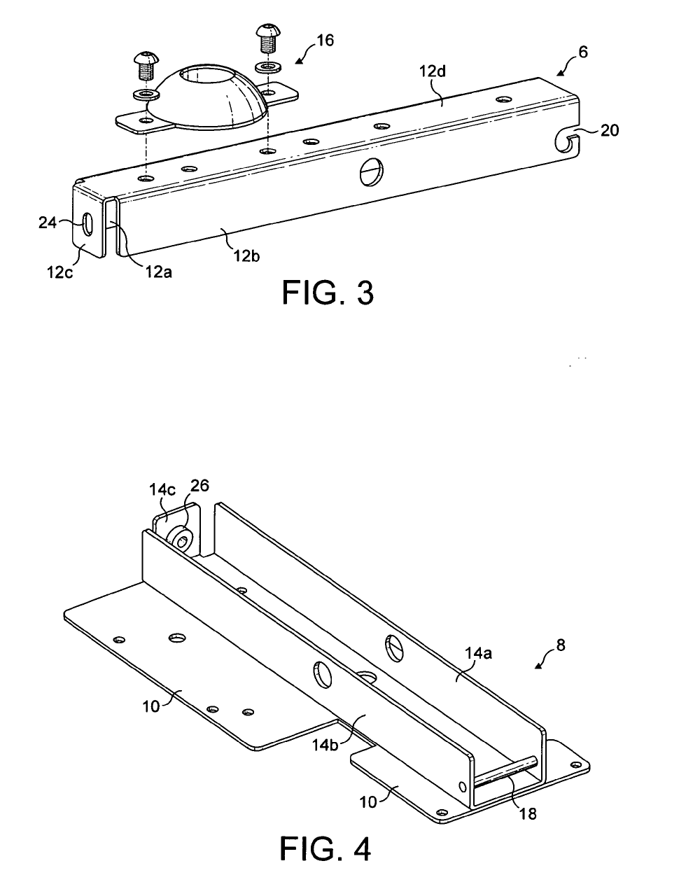

The projector mount 30 includes a first mount portion 6, and a second mount portion 8. FIG. 3 further illustrates the first mount portion 6 and FIG. 4 further illustrates the second mount portion 8.

Also illustrated in the preferred arrangement in FIG. 1 is a faceplate 10 and an armplate 16. The armplate 16 is preferably a separate element, and provided for the projector mount 30 in order to facilitate connection to the arm or boom of an integrated interactive whiteboard system. As can be seen with reference to FIGS. 1 and 2, the armplate 16 may be placed, in embodiments, in different positions on the projector mount. Thus in the illustrative example the projector mount 30 is provided with a number of alternate mounting positions for the armplate 16. The faceplate 10 is preferably an integral element, and is provided in order to facilitate connection of the projector mount 30 to the projector 2. A different shape of faceplate is shown in each of FIGS. 1 and 2, and one skilled in the art will understand that the faceplate may be shaped in numerous ways.

Each of the first mount portion 6 and the second mount portion 8 preferably comprises a respective first and second elongated portion.

With particular reference to FIG. 3, the first elongated portion of the first mount portion 6 preferably comprises a first pair of parallel elongated sidewalls denoted by reference numerals 12a and 12b. The first pair of parallel elongated sidewalls 12a and 12b generally form a first channel therebetween. The first elongated portion of the first mount portion 6 is preferably additionally provided with an end sidewall denoted by reference numeral 12c at a second end of the first channel, in a direction perpendicular to the first pair of parallel elongated sidewalls, generally forming an end-stop for the first channel. The first elongated portion of the first mount portion 6 is preferably additionally provided with an elongated channel base denoted by reference numeral 12d, which provides a connection between the first pair of parallel elongated sidewalls and holds the first pair of parallel elongated sidewalls 12a and 12b and the end sidewall 12c in position.

With particular reference to FIG. 4, the second elongated portion of the second mount portion 8 is preferably comprised of a second pair of elongated sidewalls denoted by reference numerals 14a and 14b. The second pair of elongated sidewalls 14a and 14b generally form a second channel therebetween. The second elongated portion of the second mount portion 8 is additionally provided with an end sidewall 14c at a second end of the second channel, in a direction perpendicular to the second pair of elongated sidewalls 14a and 14b generally forming an end-stop for the second channel. The second elongated portion of the second mount portion 8 is formed, in the preferred embodiment, on the faceplate 10. The faceplate 10 provides a base for the second pair of elongated sidewalls 14a, 14b and the end sidewall 14c, and holds the elongated sidewalls and the end sidewall in position.

In the preferred embodiment illustrated, the second pair of elongated sidewalls 14a and 14b forming the first channel and the end sidewall 14c are thus formed on the faceplate 10, extending vertically from the surface of the faceplate 10, and the first pair of elongated sidewalls 12a and 12b forming the second channel and the end sidewall 12c are thus formed with a fixing plate 12d. One skilled in the art will appreciate that the illustrated embodiments are shown for example only, and various modifications may be made to provide a projector mount in accordance with the invention.

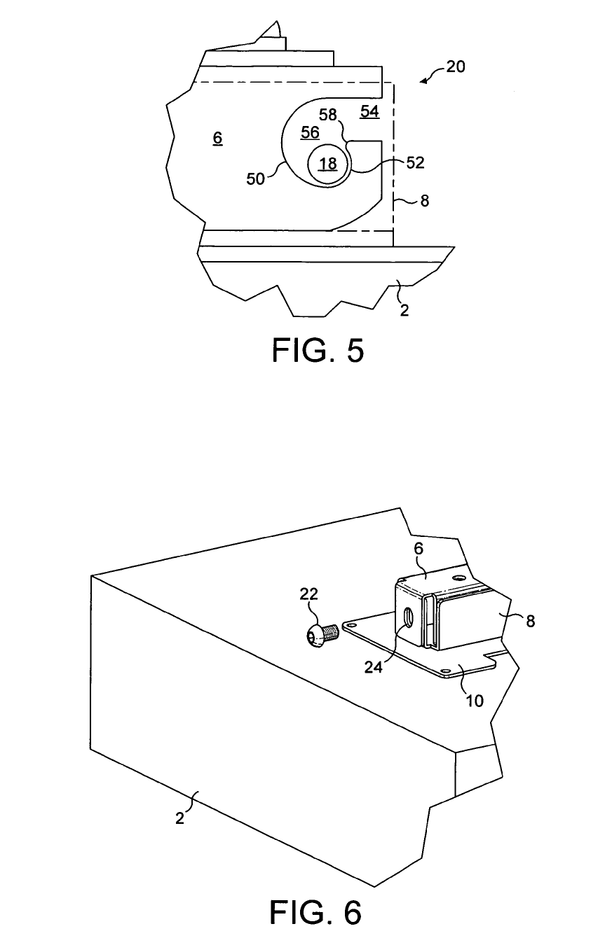

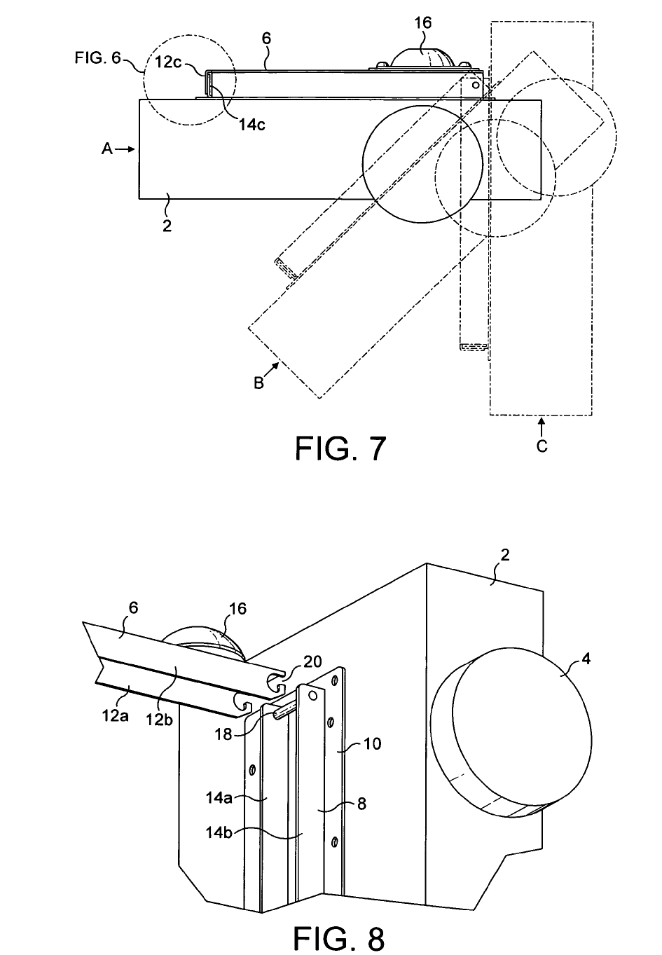

Further detail of the first and second mount portions, 6 and 8, are now described with particular further reference to FIGS. 5 and 6.

A first end of the first elongated portion of the first mount portion 6 is provided with a first pivot means generally denoted by reference numeral 20. In the preferred embodiment the first pivot means is comprised of a hook arrangement formed in the first end of each of the elongated sidewalls 12a and 12b. As can be seen in the Figures, the first end of each of the sidewalls 12a and 12b has preferably formed therein an opening which extends in the direction of the elongated portion from the first end for a short distance. The end of the opening extends within each elongated sidewall in a direction perpendicular to the direction of the elongated portion. The opening expands at a distance from the first end in a direction perpendicular to the elongated position. Thus the opening is smaller at the first end of the sidewall in comparison to a short distance from the first end of the sidewall. The opening thus forms a hook shape in the first end of each sidewall 12a and 12b.

In more detail, a first slot portion 54 of the opening 20 generally extends with parallel sides a short distance from the first end of each sidewall 12a, 12b, to form a receptacle in each sidewall 12a, 12b for the bar 18. A second portion 56 of the opening is formed to extend along the sidewall a further short distance and perpendicular to the sidewall a further short distance, the perpendicular direction being away from the channel base 12d. The second portion 56 preferably extends in the perpendicular direction to form a shape having two curved sidewalls 50, 52 extending to a base: the base forms the end of the second portion 56 in the parallel direction, and the curved sidewalls are formed such that the dimensions of the second opening, in the perpendicular direction, are smaller at and toward the base region than at the region of the first portion. Further, a third portion of each opening extends from the base along each sidewall a short distance toward the first end, such that a lip or hook shape is formed in each sidewall between the first and third portions of the opening.

A first end of the second elongated portion of the second mount portion 8 is provided with a second pivot means generally denoted by reference number 18, for engaging with the first pivot means. In the preferred embodiment the second pivot means is provided by a bar formed between the second pair of elongated sidewalls 14a and 14b at the first end thereof. As can be seen in the Figures, the first end of the sidewalls 14a and 14b are preferably formed with a bar extending therebetween, in a direction perpendicular to the elongated portion.

In a preferred embodiment, the bar 18 engages with the hooks 20 in order to connect the first mount portion 6 to the second mount portion 8. The position of the bar 18 is at a distance from the first end of the sidewalls 12a and 12b, which corresponds to the distance of the larger portion of the opening in the sidewall 14a and 14b from the end of the sidewalls 14a and 14b.

The cooperation of the first and second pivot means 18 and 20 is particularly illustrated with reference to FIG. 5. As can be seen in FIG. 5, the first pivot means 20 comprising a respective hook formed in the first end of each of the sidewalls 12a and 12b forms an internal channel or opening in each sidewall. The internal channel is formed such that the bar 18 can slide into the channel or opening formed in the sidewalls 12a and 12b by movement in the direction of the first elongated channel. Once in the channel or opening, the bar then may be moved in a perpendicular direction to the elongated channel into the larger portion of the opening at a short distance from the first end. The bar 18 may then engage with a retaining wall of the hook formed in the sidewalls 12a and 12b. The retaining wall is formed in each sidewall 12a and 12b by the extended portion of the opening forming the internal channel, the wall extending perpendicular to the elongated channel.

In more detail, the bar 18 sits in the base of the second part 56 of each opening, after being received through the first part of the opening 54. In this way the base of each of the second parts 56 of each opening takes the weight of the projector. The projector is held in the base, and the curved walls 50 and 52, and the lip or hook 58, prevent the bar 18 from being removed other than by deliberate action.

With particular reference to FIGS. 3, 4 and 6, there is illustrated the cooperation of a first fixing means of the first mount portion 6 and a second fixing means of the second mount portion 8 formed at the second ends of the first and second elongated portions.

The end sidewall 12c of the first mount portion 6 is generally provided with a first fixing means denoted by reference numeral 24 which preferably comprises a fixing slot. The end sidewall 14c of the second mount portion 8 is provided with the second fixing means generally denoted by reference numeral 26, preferably comprising a retained nut. A third fixing means denoted by reference numeral 22, and preferably comprising a screw or bolt, is provided to pass through the fixing slot 24 and engage with the retained nut 26. In a preferred arrangement the third fixing means is a winged screw.

The operation of the fixing means can be best understood with reference to the operation to secure the two parts 6 and of the projector mount 30 together. With the bar 18 positioned in the elongated internal channel of the hooks 20 the screw 22 is passed through the fixing slot 24 and engaged with the retained nut 26. The screw 22 is tightened into the retained nut 26. In doing so, the first and second portions 6 and 8 of the projector mount are secured together. As the screw is tightened, the end plate 14c is pulled toward the end plate 12c. The second mount portion 8 is thus pulled in the direction of the elongated portion toward the end plate 12c. Consequently the bar 18 is moved toward the sloping portion of the openings 20, and up the sloping portion of the retaining walls in a direction away from the first end. This forces the first mount portion 6 downward to abut mount portion 8. The two portions 6 and 8 are thus rigidly and securely connected.

With reference to FIG. 7, there is illustrated the operation which allows the projector 2 to be removed from the supporting arm to which it is fixed by the projector mount 30. The screw 22 is removed from the retained nut and fixing slot. As illustrated in FIG. 7, the projector may be then moved from a position denoted by A, through a position denoted by B, to a position denoted by C. This movement is facilitated by (i) removing the screw 22 to release the first and second projector mount portions, and (ii) pivoting about the first and second pivot means. The hook portions 20 support the weight of the projector on the bar 18 as it is pivoted downwards. Once the screw 22 is removed, the projector mount may thus pivot about the first and second pivoting means 18 and 20. Thus with the bar 18 securely positioned in the hook means 22, the projector may be moved to a stable, unsecure position approximately perpendicular to its use position by means of the pivot engagement. This position is unsecure only insofar as it is a position from which the projector may be removed.

As can be seen with further reference to FIG. 8, once the projector is pivoted into the unsecure position, a person may lift the projector upwards in a direction perpendicular to the elongated direction in order to remove it from the engaging wall of the hook 20 formed in the sidewalls 12a and 12b, and then move the projector parallel to the elongated direction in order to separate the second mount portion 8 from the first mount portion 6. In this operation the first mount portion 6 remains fixed to the boom arm, and the second mount portion 8 remains fixed to the projector.

In more detail, when the two parts of the projector mount are securely fixed, the bar 18 abuts the curved sidewall 50. When the two parts are unsecurely fixed, the bar 18 abuts the curved sidewall 52 such that it is positioned under the lip 58 and hooked in place.

The faceplate 10 may be fixed to the projector 2 by any known means, such as by screws or by welding. The armplate 16 may be fixed to the arm of the integrated interactive whiteboard system by any suitable fixing means such as by screws or by welding. In FIG. 2 the armplate 16 is shown separated from the first mount portion 6, with screws provided for fitting it to the first mount portion 6.

As can be seen from the Figures, in the preferred embodiment when the first and second mount portions 6 and 8 are fixed together, the first pair of parallel elongated sidewalls 12a and 12b sit inside the second pair of elongated sidewalls 14a and 14b. Thus the distance between the first pair of elongated sidewalls 12a and 12b may be smaller than that of the distance between the second pair of elongated sidewalls 14a and 14b. The end sidewall 14c of the second mount portion 8 preferably sits inside the end sidewall 12c of the first mount portion 6.

An important characteristic of the first and second fixing means of the first and second mount portions is that they must allow for the first and second mount portions to be fixably connected together when the projector is mounted. The preferred embodiment of the invention is particularly advantageous in providing an elongated slot in an internal channel associated with the first and second pivot means with a curved retaining wall, which allows for the first and second mount portions to be rigidly connected together when the fixing means is tightened as described above.

The invention has been described herein by way of reference to a particular preferred embodiment. One skilled in the art will appreciate that various modifications may be made to the embodiments as described herein without departing from the scope of the invention as defined by the appended claims.

1. An apparatus for mounting a projector to an overhead projector support, comprising:
a. a first mount portion including a first pivot means and a first fixing means;
b. a second mount portion including a second pivot means for cooperating with the first pivot means and a second fixing means for cooperating with the first fixing means.

2. The apparatus according to claim 1 wherein the first mount portion comprises a first elongated portion, wherein the first pivot means is positioned at a first end of the first elongated portion and the first fixing means is positioned at a position of the first elongated portion distant from the first pivot means, and the second mount portion comprises a second elongated portion, wherein the second pivot means is positioned at a first end of the second elongated portion and the second fixing means is positioned at a position of the second elongated portion distant from the second pivot means.

3. The apparatus according to claim 2 wherein the first fixing means is positioned at a second end of the first elongated portion and the second fixing means is positioned at a second end of the second elongated portion.

4. The apparatus of claim 2 or claim 3 wherein the first elongated portion comprises a first longitudinal channel and the second elongated portion comprises a second longitudinal channel, wherein the first and second longitudinal channels are arranged to cooperate with each other to connect the first and second mount portions.

5. The apparatus of claim 4 wherein the first longitudinal channel is formed of a first pair of parallel elongated sidewalls and the second longitudinal channel is formed of a second pair of parallel elongated sidewalls.

6. The apparatus of claim 5 wherein the distance between one pair of elongated sidewalls is greater than the other, such that one pair of elongated sidewalls fits inside the other.

7. The apparatus of claim 5 wherein each elongated sidewall of the first longitudinal channel is formed with a hook shape at a first end thereof, which form the first pivot means.

8. The apparatus of claim 7 wherein the second pivot means is formed of a bar between the ends of the sidewalls at the second end of the second longitudinal channel.

9. The apparatus of claim 5 wherein the first longitudinal channel comprises a further sidewall forming an end sidewall at the second end thereof between the parallel sidewalls.

10. The apparatus of claim 9 wherein the first fixing means comprises a fixing slot positioned in the further sidewall.

11. The apparatus of claim 5 wherein the second longitudinal channel comprises a further sidewall forming an end sidewall at the second end thereof between the parallel sidewalls.

12. The apparatus of claim 11 wherein the second fixing means comprises a retained nut in the further sidewall of the second longitudinal channel.

13. The apparatus of claim 12 wherein there is provided a third fixing means for securing the first and second means.

14. The apparatus of claim 13 wherein the third fixing means is a screw which passes through the fixing slot to engage with the retained nut.

15. The apparatus of claim 14, wherein the slot is an elongated slot having a retaining wall, wherein when the screw is secured the second fixing means abuts the retaining wall to fix the first and second mount portions.

16. The apparatus of claim 2 wherein the first pivot means includes an elongated slot in the first elongated portion, and the second pivot means includes means for engaging said slot, wherein with the first and second fixing means unsecured the second pivot means can slide in and out of said elongated slot, and with the first and second fixing means secured the second pivot means abuts an edge of the elongated slot to prevent movement of the second mount portion relative to the first mount portion.

17. The apparatus of claim 16, wherein the elongated slot extends along the sidewall from the first end thereof for a fixed distance, wherein a first portion of the elongated slot adjacent the first end provides a channel for receiving the second pivot means, and a second portion of the elongated slot distal the first end extends in a direction perpendicular to the elongated channel.

18. The apparatus of claim 17, wherein the elongated slot further comprises a third portion extending from the perpendicularly extended part of the second portion in the direction of the elongated slot partially toward the first end, and in the perpendicular direction partially toward the first portion.

19. The apparatus of claim 18 wherein the wall of the third portion distal the first end is curved.

20. The apparatus of claim 19 wherein with the first and second mount portions secured, the second pivot means abuts the curved wall distal the first end.

21. The apparatus of claim 18 wherein the wall of the third portion proximate the first end is curved.

22. The apparatus of claim 21 wherein with the first and second mount portions unsecured the second pivot means abuts the curved wall proximate the first end.

23. The apparatus according to claim 1 wherein the first mount portion is adapted for fixing to a support boom for the projector.

24. The apparatus of claim 1 second mount portion is adapted for fixing to the projector.

25. The apparatus of claim 24 wherein the second mount portion is welded to a faceplate.
